(19) United States
(12) Patent Application Publication
(10) Pub. No.: US 2008/0105145 A1
(43) Pub. Date: May 8, 2008

(54) COMPOSITE PRINTING PAD

(76) Inventors: CHRISTOPHER SCHAAFSMA, Wheaton, IL (US); Tom Guastaferri, West Chicago, IL (US)

Correspondence Address: CARDINAL LAW GROUP, Suite 2000, 1603 Orrington Avenue, Evanston, IL, 60201, US

(21) Appl. No.: 11/928,995

(22) Filed: Oct. 30, 2007

Related U.S. Application Data
(60) Provisional application No. 60/864,518, filed on Nov. 6, 2006.

(51) Int. Cl. B41F 17/00

(52) U.S. Cl. 101/41

(57) ABSTRACT

A pad for use in pad printing includes an inner core including a first set of physical characteristics. In addition, the pad includes an outer contact pad disposed on the inner core, the outer contact pad including an ink contact surface, the outer contact pad including a second set of physical characteristics, wherein the first set of characteristics is different than the second set of characteristics.

### RELATED APPLICATIONS

This application claims the benefit of, and priority to, U.S. Provisional Application 60/864,518 filed Nov. 6, 2006.

### TECHNICAL FIELD OF THE INVENTION

The present invention relates generally to pad printing and in particular to pads for pad printing.

### BACKGROUND OF THE INVENTION

Pad printing has been used for many years to apply an image to a product. Pad printing is especially prevalent in applications for applying images to rounded or specially contoured products, such as syringes and golf balls.

In a typical pad printing system, a negative image is etched onto a surface of a cliché plate, leaving a raised positive image on its surface. The etched cliché plate receives a coating of ink. A doctor blade device removes excess ink from the inked plate, such as by moving the doctor device and cliché plate relative to each other. A pliable pad is pressed against the inked and doctored cliché plate, picking up ink in the pattern of the positive image, and the inked pad is then pressed against the product, transferring the image to the product. A doctor blade device is a knife-like blade that is used to scrape the puddle of ink from the clichés surface, leaving only the ink in the etched image. Doctor blades are found on open inkwell systems.

Historically, ink pads have been formed from silicone, polyurethane, and other such materials. The material must be sufficiently pliable as to deform against the object receiving the transferred ink and possibly the cliché plate, while being durable enough to last many iterations. Unfortunately, such materials tend to be relatively expensive.

Additionally, in some applications, the quality of the ink transfer is limited by the shape of the item being printed, as well as other factors.

Therefore, it would be desirable to create a pad that would overcome the aforementioned and other disadvantages.

### SUMMARY OF THE INVENTION

One aspect of the present invention provides a pad for use in pad printing. The pad includes an inner core including a first set of physical characteristics. In addition, the pad includes an outer contact pad disposed on the inner core, the outer contact pad including an ink contact surface, the outer contact pad including a second set of physical characteristics, wherein the first set of characteristics is different than the second set of characteristics.

Another aspect of the invention provides a system for pad printing includes a cliché device and a pad for use in pad printing. The system includes an inner core including a first set of physical characteristics, and an outer contact pad disposed on the inner core, the outer contact pad including an ink contact surface, the outer contact pad including a second set of physical characteristics, wherein the first set of characteristics is different than the second set of characteristics.

Another aspect of the invention provides a pad for use in pad printing. The pad includes an inner core including a first set of physical characteristics. In addition, the pad includes an outer contact pad disposed on the inner core, the outer contact pad including means for covering the inner core and picking up ink from a cliché device and printing on a print object.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1A illustrates an isometric view of one embodiment of a pad for pad printing in accordance with one embodiment of the invention;

FIG. 1B illustrates a side cross section view of one embodiment of a pad for pad printing in accordance with one embodiment of the invention;

FIG. 1C illustrates a top cross section view of one embodiment of a pad for pad printing in accordance with one embodiment of the invention;

FIG. 2 illustrates an embodiment of a system for pad printing, in accordance with another aspect of the invention;

FIG. 3 illustrates one embodiment of a method for forming a composite pad, in accordance with one aspect of the invention; and

FIG. 4 illustrates one embodiment of a method for printing a print object, in accordance with another aspect of the invention.

### DETAILED DESCRIPTION OF THE PRESENTLY PREFERRED EMBODIMENTS

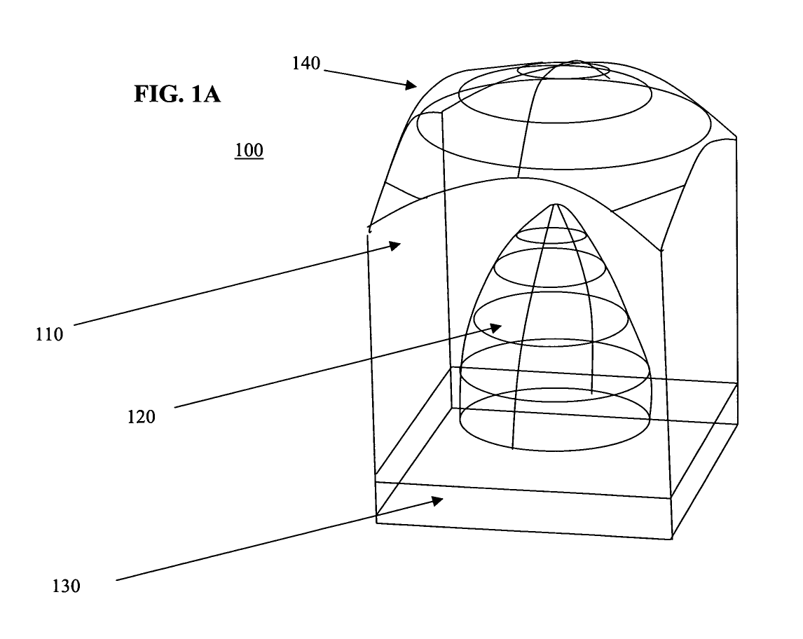

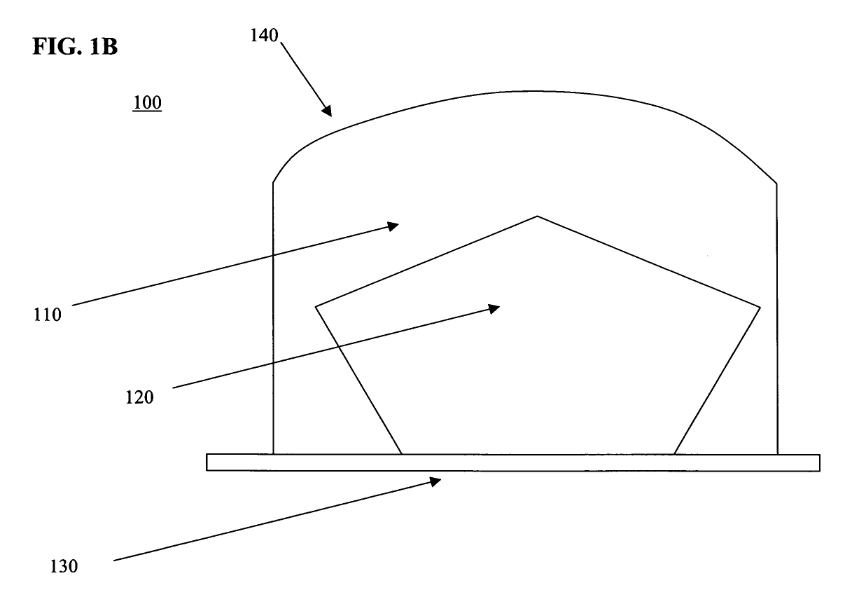

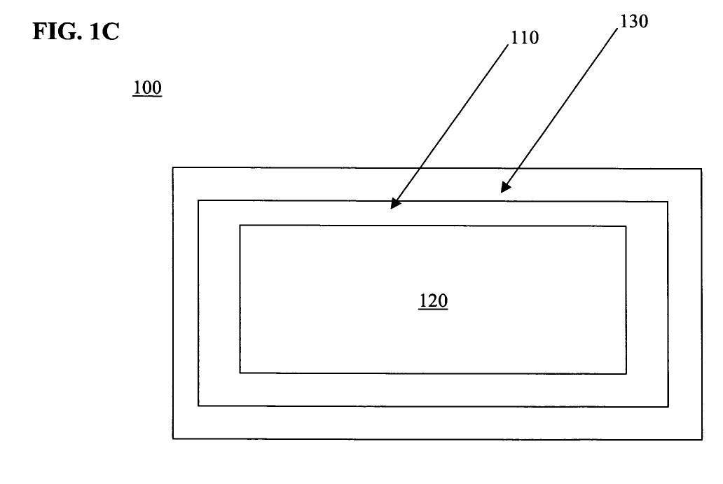

FIG. 1A illustrates an isometric view of one embodiment of a composite pad 100 in accordance with one aspect of the invention. Pad 100 includes outer contact pad 110 and inner core 120 disposed on a base 130. FIG. 1B illustrates a side cross-sectional view of a different embodiment of a composite pad, using similar numbers to indicate similar structures. FIG. 1C illustrates a top cross section view of a different embodiment of a composite pad, using similar numbers to indicate similar structures. Although FIGS. 1B and 1C illustrate outer contact pad 110 as entirely covering the inner core 120, this depiction is not a limitation of this disclosure.

Inner core 120 includes a first set of physical characteristics. In one embodiment, the physical characteristic is durometer. As used herein, the term “durometer” is used as a reference to a measure of hardness, and specifically to a resistance of a material to permanent indentation. Durometer, as expressed herein, can be measured using any appropriate scale, such as A, B, C, D, DO, E, M, O, OO, OOO, OOO-S, or R per ASTM testing standard D2240-00. The durometer of a particular material is dependent on the hardness, viscoelasticity, shape of the testing device, and the duration of the test. Hardness of a material refers to a material's ability to penetrate softer materials. Additionally, inner core 120 is composed of an appropriate material, such as silicone, polyurethane, rubber, plastic, or the like. In addition, the first set of physical characteristics may also include color, texture, and hardness. In one embodiment, the color of the inner core 120 is color coded to a separate property of the inner core 120, such as shape, durometer, or the like.

Outer contact pad 110 includes a second set of physical characteristics. In one embodiment, the second physical characteristic is durometer. Additionally, outer contact pad 110 can comprise any appropriate material for receiving ink from a cliché device and transferring the received ink to an object. Outer contact pad 110 also includes ink contact surface 140 for picking up ink from a cliché device and imprinting the picked up ink onto an object. In addition, the second set of physical characteristics may also include color, texture, and hardness.

The first set of physical characteristics differs from the second set of physical characteristics. In one embodiment, the outer contact pad comprises silicone with a relatively lower durometer, while the inner core comprises polyurethane with a relatively higher durometer. In one embodiment, the color of the outer contact pad 110 is color coded to the durometer of the outer contact pad 110.

In one embodiment, the inner core is shaped to be complementary to a shape of a print object. For example, if the pad 100 is to be used to transfer ink to a curved object, such as a golf ball or syringe, the inner core 120 can be shaped to complement the golf ball shape. In such embodiments, the shape of the inner core can increase the contact force between the outer contact pad and the print object. In another embodiment, the inner core comprises a bullet shape, such as the shape illustrated in FIG. 1. Similarly, the outer contact pad 110 can comprise a plurality of shapes, such as a polygon. Alternatively, outer contact pad 110 can be shaped to be complementary to the print object. As used herein, the term “complementary” refers to a shape that is substantially matched to another shape. When complementary surfaces meet, a space between the surfaces is reduced. For example, two surfaces with similar radii are complementary. In another example, a concave surface with a given radius is complementary to a convex surface with a radius just smaller than the given radius, such that the convex surface mates with the concave surface. Thus, for example, when printing a print object on a convex surface, the inner core 120 includes a concave surface matched to the convex surface of the print object. Conversely, when printing a print object on a concave surface, the inner core 120 includes a convex surface matched to the concave surface of the print object. In another example, when printing a golf ball, the inner core 120 includes a series of convex dimples matched to the concave dimples on the golf ball surface.

In one embodiment, outer contact pad 110 is at least partially translucent and the inner core is at least partially non-translucent so that light reflects from a surface of the inner core. In such an embodiment, light passes through the outer contact pad and at least partially reflects off the inner core and passes back through the outer contact pad. In these embodiments, the inner core is thus visible from outside the pad. In one embodiment, the outer contact pad 110 has a durometer of 30-75 shore.

In one embodiment, inner core 120 and outer contact pad 110 are adhered together with an adhesive. Depending on application, the adhesive can be non-structural or structural. In other embodiments, inner core 120 and outer contact pad 110 are not adhered together. In one embodiment, outer contact pad 110 connects to base 130, surrounding inner core 120 and maintaining inner core 120 in place. In such embodiments, outer contact pad 110 can be structurally or non-structurally adhered to base 130.

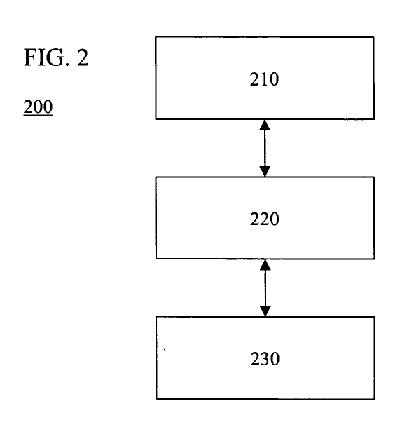

FIG. 2 illustrates one embodiment of a system 200 for pad printing, in accordance with one aspect of the invention. System 200 includes a cliché device 210 and a pad 220 for use in pad printing. The pad 220 is implemented as in FIG. 1, and includes an inner core including a first set of physical characteristics and an outer contact pad disposed on the inner core, the outer contact pad including an ink contact surface, the outer contact pad including a second set of physical characteristics. The first set of characteristics is different than the second set of characteristics. In one embodiment, illustrated in FIG. 2, system 200 further includes a device 230 for holding an object to be printed. Cliché device 210 can be any appropriate cliché device for receiving ink, such as a cliché plate, Gravure wheel, or other such device.

In operation of system 200, ink is deposited on the cliché device 210, and pad 220 is pressed against the inked cliché device 210, picking up at least a portion of the deposited ink. Pad 220 is then translated to press against an object held by device 230 to transfer an image engraved in the cliché device to the object held by device 230. Having transferred the image, the pad 220 is then translated back to the cliché device 210 to pick up additional ink to print another object.

Use of the disclosures herein can allow the appearance of pads for use in pad printing to differentiate products from a manufacturer or supplier, custom design for different physical properties in different areas of the pad, and/or use of lower grade materials for the inner core and higher grade materials for the outer contact pad.

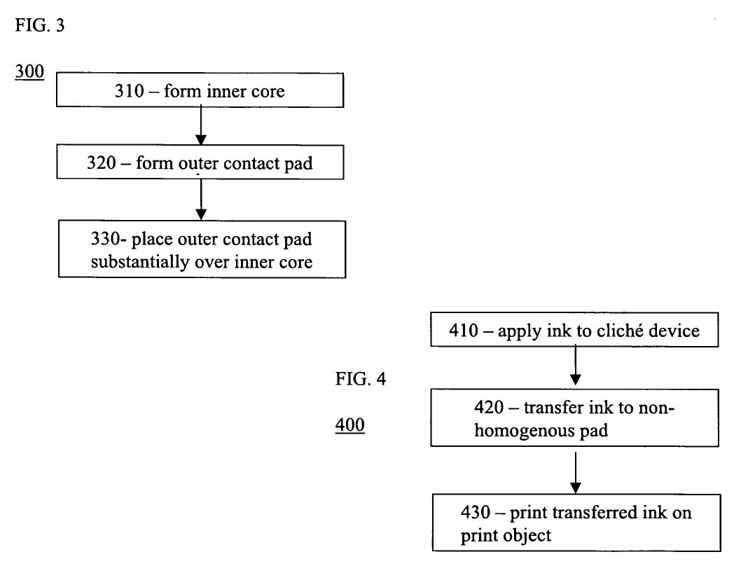

FIG. 3 illustrates a flowchart of a method 300 for manufacturing a composite pad for pad printing a print object in accordance with one aspect of the invention. Method 300 begins by forming an inner core including a first set of physical characteristics. The inner core is implemented as in inner core 120 (block 310). An outer contact pad, implemented as outer contact pad 110, is formed (block 320). The outer contact pad includes an ink contact surface and a second set of physical characteristics. The first set of physical characteristics is different than the second set of physical characteristics. The formed outer contact pad is placed substantially over the formed inner core to form the composite pad for pad printing (block 330).

In one implementation of method 300, the first set of physical characteristics includes a first durometer and wherein the second set of physical characteristics includes a second durometer, and wherein the first durometer is different than the second durometer.

FIG. 4 illustrates a flowchart of a method 400 for printing a print object using a composite pad in accordance with one aspect of the invention. Method 400 begins by applying ink to a cliché device (block 410). The cliché device can be a cliché plate or Gravure wheel. The ink can be any appropriate ink for use in pad printing. The applied ink is transferred to a composite pad (block 420). The composite pad includes an inner core, such as inner core 120, including a first set of physical characteristics and an outer contact pad, such as outer contact pad 110, disposed substantially over the inner core. The outer contact pad includes an ink contact surface, the outer contact pad including a second set of physical characteristics, wherein the first set of physical characteristics is different than the second set of physical characteristics. The transferred ink is printed on the print object using the composite pad (block 430).

In one implementation of method 400, the first set of physical characteristics includes a first durometer and wherein the second set of physical characteristics includes a second durometer, and wherein the first durometer is different than the second durometer.

A composite pad as disclosed herein can provide multiple benefits over the prior art. For example, the use of a pad that includes distinct durometers for an inner core and outer contact pad can improve ink transfer. This is particularly true in the case of a complexly contoured object, such as a golf ball. In addition, use of a pad that includes distinct durometers for an inner core and outer contact pad can provide cost benefits via use of less expensive materials for the inner core than the outer contact pad. Further, in the event of a relatively translucent outer contact pad, the inner core can be color coded to provide information to an operator. The information can include intended product application (i.e. an inner core colored green is associated with golf balls, while an inner core colored red is associated with syringes, etc.), or durometer information (data indicative of physical properties can be imprinted on the inner core and visible from the exterior. Additionally, the visual appearance may be considered desirable.

It is important to note that the figures and description illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A pad for use in pad printing a print object, comprising:
a base;
an inner core disposed on the base, the inner core including a first set of physical characteristics; and
an outer contact pad disposed substantially over the inner core, the outer contact pad including an ink contact surface, the outer contact pad including a second set of physical characteristics, wherein the first set of physical characteristics is different than the second set of physical characteristics.

2. The pad of claim 1 wherein the inner core has a shape complementary to a shape of the print object.

3. The pad of claim 2 wherein the outer contact pad is non-complementary to the print object

4. The pad of claim 1 wherein the first set of characteristics and second set of characteristics comprise one or more characteristics selected from the group consisting of color, texture, and hardness.

5. The pad of claim 1 wherein the first set of characteristics and second set of characteristics comprise durometer.

6. The pad of claim 1 wherein the outer contact pad is substantially polygonal.

7. The pad of claim 6 wherein the inner core comprises a bullet shape.

8. The pad of claim 1 wherein the outer contact pad is at least partially translucent and wherein light reflects from a surface of the inner core.

9. A system for pad printing a print object, the system comprising:
a cliché device; and
a pad for use in pad printing the print object, the pad comprising:
a base;
an inner core including a first set of physical characteristics; and
an outer contact pad disposed substantially over the inner core, the outer contact pad including an ink contact surface, the outer contact pad including a second set of physical characteristics, wherein the first set of physical characteristics is different than the second set of physical characteristics.

10. The system of claim 9 wherein the inner core has a shape complementary to a shape of the print object.

11. The system of claim 10 wherein the outer contact pad is non-complementary to the print object

12. The system of claim 9 wherein the first set of characteristics and second set of characteristics comprise one or more characteristics selected from the group consisting of durometer, color, texture, and hardness.

13. The system of claim 9 wherein the outer contact pad is substantially polygonal.

14. The system of claim 13 wherein the inner core comprises a bullet shape.

15. The system of claim 9 wherein the outer contact pad is at least partially translucent and wherein light reflects from a surface of the inner core.

16. A pad for pad printing, the pad comprising:
an inner core including a first set of physical characteristics; and
means for covering the inner core and picking up ink from a cliché device and printing on a print object, the means for covering including a second set of physical characteristics, wherein the first set of physical characteristics is different than the second set of physical characteristics.

17. A method of manufacturing a composite pad for pad printing a print object, the method comprising:
forming an inner core including a first set of physical characteristics;
forming an outer contact pad including an ink contact surface, the outer contact pad including a second set of physical characteristics, wherein the first set of physical characteristics is different than the second set of physical characteristics; and
placing the outer contact pad substantially over the inner core.

18. The method of claim 17 wherein the first set of physical characteristics includes a first durometer and wherein the second set of physical characteristics includes a second durometer, and wherein the first durometer is different than the second durometer.

19. A method of printing a print object using a composite pad, the method comprising:
applying ink to a cliché device;
transferring the applied ink to a composite pad, the composite pad including an inner core including a first set of physical characteristics and an outer contact pad disposed substantially over the inner core, the outer contact pad including an ink contact surface, the outer contact pad including a second set of physical characteristics, wherein the first set of physical characteristics is different than the second set of physical characteristics;
printing the transferred ink on the print object using the composite pad.

20. The method of claim 19 wherein the first set of physical characteristics includes a first durometer and wherein the second set of physical characteristics includes a second durometer, and wherein the first durometer is different than the second durometer.
